(19) United States
(12) Patent Application Publication
(10) Pub. No.: US 2017/0144372 A1
(43) Pub. Date: May 25, 2017

(54) Powder-Bed-Based Additive Production Method And Installation For Carrying Out Said Method

(71) Applicant: Siemens Aktiengesellschaft, Muenchen (DE)

(72) Inventors: Yves Kuesters, Berlin (DE); Martin Schaefer, Berlin (DE)

(73) Assignee: Siemens Aktiengesellschaft, Muenchen (DE)

(21) Appl. No.: 15/321,790

(22) PCT Filed: Jun. 16, 2015
(86) PCT No.: PCT/EP2015/063440

§ 371 Date: Dec. 23, 2016

(30) Foreign Application Priority Data
Jun. 25, 2014 (DE) 10 2014 212 176.0

(51) Int. Cl. B29C 67/00; B28B 1/00; B33Y 10/00; B33Y 30/00; B22F 3/16; B22F 3/105

(52) U.S. Cl. CPC B29C 67/0077; B22F 3/16; B22F 3/1055; B33Y 10/00; B33Y 30/00; B28B 1/001; B29C 67/0085; B22F 2003/1056; B22F 2003/1058; B29K 2105/251

(57) ABSTRACT

A powder-bed-based, additive production method for producing a component is disclosed. Individual layers are applied by a support component onto the powder bed in which the component is produced. Each layer can be removed from a supply powder bed having the same dimensions as the powder bed, and the layer can be compressed using a compressor. High quality layers may be produced in this manner. The layers may be compressed and flat as a result of their contact to the carrier component, e.g., the support component. The quality of the component that is produced can thus also be improved.

### CROSS-REFERENCE TO RELATED APPLICATIONS

This application is a U.S. National Stage Application of International Application No. PCT/EP2015/063440 filed Jun. 16, 2015, which designates the United States of America, and claims priority to DE Application No, 10 2014 212 176.0 filed Jun. 25, 2014, the contents of which are hereby incorporated by reference in their entirety.

### TECHNICAL FIELD

The invention relates to a powder-bed-based additive production method, in which a layer of a powder is repeatedly applied onto a powder bed. The powder is subsequently selectively fused using an energy beam with the simultaneous formation of a layer of a component to be produced. Thus, the component to be produced is created in the powder bed in layers.

Furthermore, the invention relates to an installation for carrying out a powder-bed-based additive production method, having a processing chamber, in which a powder bed can be generated on a building platform. A dosing device, using which a layer can be generated on a powder bed located on the building platform, is furthermore located in the processing chamber.

### BACKGROUND

A powder-bed-based additive production method and an installation for carrying out the same are known for example from US 2003/0074096 A1. In order to generate a powder bed which is as uniform as possible, it is suggested that the powder is supplied individually to an array of funnels via a supply line, wherein the funnels of the array locally ensure a precise dosing of the powder. As a result, overall, the uniform application of the powder over the entire surface of the powder bed can be ensured. However, the individual funnels of the funnel array must be travelled to individually by the supply device for the powder, which entails a certain feeding time during operation.

It is furthermore known from 3D printing technology according to US 2002/0145213 A1 that powder for printing the individual layers of a component to be produced can be supplied by means of a suitable supply device, wherein, as is conventional in the case of laser printers, the powder of the individual layers provisionally adheres by means of electrostatic charging of those regions which should form the layer of the component to be produced. These particles are subsequently fused by means of energy supply.

Furthermore, it is generally known that the powder in powder-bed-based additive production methods can be scattered onto the powder bed by means of a dosing device, wherein a scraper is subsequently pulled over the surface of the powder bed, in order to ensure a uniform distribution of the powder on the powder bed. Here, process reliability for producing a smooth powder bed is limited however. Signs of wear on the scraper and component faults on the surface may lead to the surface of the powder bed being formed in an uneven manner, e.g. containing grooves or ridges. Upon subsequent fusing of the powder, these lead to imperfections in the component produced. In order to curtail these effects to the greatest extent possible, powders with a high powder quality are used, for example gas atomized powders can be used, wherein these powders are more expensive to purchase compared to other powder types.

### SUMMARY

One embodiment provides a powder-bed-based additive production method, in which repeatedly: a layer of a powder is applied onto a powder bed, using an energy beam, the powder is fused selectively, with the simultaneous formation of a layer of a component to be produced, wherein, to apply the layer onto the powder bed: the layer to be applied is formed and compacted outside of the powder bed, the layer formed is temporarily held on a substrate component, the layer formed is deposited with the substrate component on the powder bed, and the temporary bond between the layer and the substrate component is dissolved.

In one embodiment, an auxiliary plate is provided for forming the layer and the layer is subsequently removed from the auxiliary plate with the substrate component.

In one embodiment, the formation of the layer takes place with the substrate component in that the layer is produced as a single entity by picking up powder from a supply powder bed.

In one embodiment, the powder is compacted on the auxiliary plate or the substrate component after the formation of the layer using a compacting plate, in that the compacting plate is pressed onto the layer.

In one embodiment, the powder is compacted on the auxiliary plate after the formation of the layer using the substrate component, in that the substrate component is lowered onto the layer.

In one embodiment, the substrate component and/or the auxiliary plate and/or the compacting plate is/are loaded with mechanical vibrations, particularly in the ultrasonic range, to support the compacting of the powder.

In one embodiment, the substrate component has a channel system which is open towards the surface thereof, and the layer is held on the substrate component with the aid of a vacuum.

In one embodiment, the layer is held on the substrate component with the aid of magnetic or electrostatic forces.

In one embodiment, the substrate component and/or the auxiliary plate is heated whilst the same are in contact with the layer.

In one embodiment, the density and/or the temperature and/or pressure differences in the layer are detected sensorially, whilst the same is located on the auxiliary plate and/or on the substrate component and/or on the compacting plate.

In one embodiment, the layer is compacted after deposition on the powder bed.

In one embodiment, the compacting of the layer takes place in the powder bed using a compacting plate.

In one embodiment, powder is used to produce the layer, in which powder the particles have particle diameters in the region of two orders of magnitude.

Another embodiment provides an installation for carrying out a powder-bed-based additive production method, having a processing chamber in which a powder bed can be generated on a building platform, and in which there is a dosing device, using which a layer can be generated on a powder bed located on the building platform, wherein a substrate component is provided as dosing device in the processing chamber, on which the layer can be generated and fixed, which can be lowered, with the layer first onto the powder bed.

In one embodiment of the installation, an auxiliary plate is provided for provisionally generating the layer and subsequently transferring the layer onto the substrate component and/or a compacting plate is provided for compacting the layer.

In one embodiment, the substrate component and/or the auxiliary plate and/or the compacting plate is coated with a layer reducing the adhesion of the powder.

### BRIEF DESCRIPTION OF THE DRAWINGS

Example aspects and embodiments of the invention are described in detail below with referenced to the drawings, in which:

FIGS. 1 and 2 show exemplary embodiments of the installation according to the invention for carrying out the additive production method in each case in a schematic section,

FIG. 3 shows an exemplary embodiment for a substrate component as can be used in the installation according to FIGS. 1 and 2, and

FIGS. 4 to 10 show selected production steps of two exemplary embodiments of the production method according to the invention, as can be carried out with the installations according to FIGS. 1 and 2.

### DETAILED DESCRIPTION

Embodiments of the invention may develop a powder-bed-based additive production method specified at the beginning in such a manner that a time-saving application of powder onto the powder bed becomes possible and the quality of the powder bed is improved particularly with regards to the surface formed by the powder bed. In addition, it is the object of the invention to equip an installation for carrying out a powder-bed-based additive production method specified at the beginning such that such an improved method can be carried out with this installation.

Some embodiments provide an additive production method in which a substrate component is used for applying the layer onto the powder bed, with the aid of which substrate component a prefabricated layer can be transferred as a whole onto the powder bed. Here, the following steps are carried out. The layer to be applied is formed and compacted outside of the powder bed. To do this, a suitable substrate must be available, wherein this is described in more detail in the following. The solidification of the layer is required at least to the extent that the layer is stable enough in order to be transferred onto the powder bed using suitable auxiliary means. In a next step, the layer formed is temporarily held on a substrate component. Retaining forces are necessary for this, which retaining forces must be applied by the substrate component (more on this in the following). Furthermore, the layer formed is deposited with the substrate component on the powder bed. In this case, the layer hangs below the substrate component so to speak, so that the layer can be placed onto the powder bed from above. The aforementioned retaining forces ensure that the layer does not fall down during this handling movement of the substrate component. If the layer has been deposited on the powder bed, then the temporary bond between the layer and the substrate component is subsequently dissolved again. This takes place by cancelling the retaining forces. The substrate component can then be lifted off and leaves behind the layer on the powder bed. Then the additive production method can be continued in that the subregions of the layer forming the component are fused by means of an energy beam. Selective laser melting or selective electron beam melting are preferably carried out.

The application according to the invention of a layer on the powder bed as a single entity has the advantage that the layer does not have to be smoothed using a scraper or a similar tool. The provisional solidification of the layer even before holding the same on the substrate component has the advantage that the layer can, in the case of careful handling, be deposited on the powder bed as a single entity and not in the form of individual powder particles. After lifting off the substrate component, a smooth surface of the powder bed is therefore exposed, which is advantageously substantially smoother than the surface of powder beds produced according to conventional methods. As a result, a good component result can advantageously be produced by means of the additive production method.

One embodiment of the invention provides that an auxiliary plate is provided for forming the layer and the layer is subsequently removed from the auxiliary plate with the substrate component. The auxiliary plate can advantageously be used for the application of powder using the dosing method which is known per se and subsequent scraping. Here, recourse to the existing prior art can advantageously be had. It is also possible for installations for additive production that are already used and have powder dosing devices and scraper devices to be modified with the auxiliary plate, so that these conventional installations can be operated using the improved method. Unevennesses, which occur during scraping of the layer on the auxiliary plate, are irrelevant for the component to be produced, because the unevennesses are subsequently compensated by placing the substrate component onto the powder particles.

A different design of the invention is obtained if the formation of the layer takes place with the substrate component in that the layer is produced as a single entity by picking up powder from a supply powder bed. The supply powder bed forms a complementary powder bed, so to speak, in the processing chamber of the installation for the additive production of components. It preferably has the same surface shape and size as the powder bed, so that powder layers can be removed from the supply powder bed, which powder layers fit precisely into the powder bed for producing the relevant component. In this case, the supply powder bed is depleted successively layer by layer, whilst the powder bed for producing the component grows layer by layer.

The use of a supply powder bed has a plurality of advantages. The required powder quantity for a component to be produced can, with knowledge of the powder bed required for producing the component, advantageously be dosed precisely. In addition, the mounting of layers by means of the substrate component can advantageously take place very fast, because the layer can in each case be produced as a single entity by placing the substrate component on the auxiliary powder bed. The auxiliary power bed is also advantageously of much simpler build than the dosing devices and scraper devices which are complex by comparison therewith must carry out comparatively complex movement sequences.

A further design of the invention provides that the powder is compacted on the auxiliary plate or the substrate component after the formation of the layer using a compacting plate, in that the compacting plate is pressed onto the layer. Thus, a particular unit is provided in the installation for the additive production of components, which unit only pursues the purpose of compacting by pressing the particles onto the auxiliary plate or the substrate component. As a result, the mechanical stability of the layer is advantageously increased. In addition, when pressing against the substrate component is taking place, the retaining force of the substrate component for the layer can also be improved e.g. by means of adhesion effects.

Furthermore, the powder may be compacted on the auxiliary plate after the formation of the layer using the substrate component, in that the substrate component is lowered onto the layer. If an auxiliary plate is provided for the formation of the layer, then a pairing of components already advantageously exists, with which components a compacting of the layer can take place: namely the substrate component and the auxiliary plate. In such a case, a separate compacting plate can advantageously be dispensed with. By compacting the provisional layer located on the auxiliary plate, the provisional layer is advantageously transferred onto the substrate component in a process step.

It may be advantageous if the substrate component and/or the auxiliary plate and/or the compacting plate (depending on which of these components is used in the installation) is or are loaded with mechanical vibrations, particularly in the ultrasonic range, to support the compacting of the powder. For this purpose, the substrate component and/or the auxiliary plate and/or the compacting plate must be mechanically coupled with a vibration generator. The vibration generator can for example consist of an ultrasound probe. Mechanical vibrations of lower frequency can also be generated by means of mechanical vibrating heads with a motor drive. By using a vibration generator, the compacting of the layer is advantageously supported, as a result of which the layer receives greater mechanical stability. A vibration generator in the substrate component can moreover be used in order to support a separation of the substrate component from the layer after the placement of the layer onto the powder bed, in that adhesion forces between the particles and the layer are cancelled.

One embodiment of the invention provides that the substrate component has a channel system which is open towards the surface thereof, and the layer is held on the substrate component with the aid of a vacuum. This channel system may have a certain geometry. Alternatively, it is also possible to realize the material of the substrate component in an open-pored porous manner so that the pores also open towards the surface. By applying a negative pressure to the surface, a vacuum is created, which generates a retaining force on the layer formed. The layer itself likewise has an open-pored structure owing to a residual porosity, so that a leakage flow through the layer is created. This leakage flow must constantly be compensated by means of a vacuum pump, which is connected to the channel system. The mechanical stability of the layer in this case ensures that this volumetric flow caused by the leakage is not degraded.

Alternatively, according to a different embodiment of the invention, the layer can also be held on the substrate component with the aid of magnetic or electrostatic forces. For this purpose, the substrate component itself must be flooded by a magnetic field, which can be ensured by means of an external magnet on the rear side of the substrate component. The substrate component can also particularly advantageously be produced from a ferromagnetic material such as iron, so that the magnetic field on the surface of the substrate component is strengthened. By removing the magnetic field from the substrate component, preferably by switching off an electrical coil generating the magnetic field, the retaining force can be cancelled and the layer can be deposited on the powder bed. In the event of the generation of electrostatic forces, the material of the layer and/or the material of the substrate component must be formed from an electrical insulator, so that the contacting of the layer with the substrate component does not lead to an electron flow and therefore degrading of the electrostatic forces. Cancelling of the electrostatic forces is then implemented by means of suitable supplies of electrons into the pairing between layer and substrate component.

In addition, the substrate component and/or the auxiliary plate may be heated whilst the same are in contact with the layer. Heating the particles can on the one hand support the compacting process. In addition, the layer can be preheated before depositing on the powder bed, which entails advantages with regards to the creation of the component by means of the energy beam. Then only a smaller additional power must advantageously be introduced into the layer using the energy beam, so that the layer is fused. Even the formation of residual stresses in the component to be produced can be reduced in this manner.

In addition, the density and/or the temperature and/or pressure differences in the layer may be detected sensorially, whilst the layer is located on the auxiliary plate and/or on the substrate component. The sensorial detection takes place by means of suitable sensors, which are attached on the auxiliary plate and/or on the substrate component. The sensors must be attached in the sphere of influence of the value to be measured in each case. A temperature sensor must be in at least indirect thermal contact with the auxiliary plate or the substrate component or the layer. Pressure differences can be determined in that pressure sensors are attached above and below the layer. This can take place for example in that in each case pressure sensors are provided in the auxiliary plate and the compacting plate or in the compacting plate and the substrate component or in the auxiliary plate and the substrate component, depending on which of the plate pairings mentioned are used for compacting the layer. A density investigation can take place very simply by measuring the layer thickness and the weight or mass of the substrate component loaded with the layer. Statements with regards to the thickness of the layer allow conclusions about the result of the additive production method to be achieved.

It may be advantageous if the layer is compacted after depositing on the powder bed. This can take place for example by means of the substrate component before the substrate component is removed. Alternatively, the compacting of the layer in the powder bed can also be carried out by means of a compacting plate. A subsequent compacting on the powder bed is advantageous for example if the preceding compacting has not led to the required density of the layer. A different option is to also compensate any mechanical instabilities (cracks, unevennesses), which have arisen during the handling of the layer, after the placement of the layer onto the powder bed. Also, when compacting the layer on the powder bed, a vibration exciter, particularly an ultrasound generator can be used, which is attached on the substrate component, on the compacting plate or in the powder bed, e.g. on the building platform supporting the powder bed.

Advantageously, powder can be used to produce the layer, in which powder the particles have particle diameters in the region of 2 orders of magnitude. Here, these are powder types which are inexpensive to purchase due to the low size classification requirements. Also (as mentioned at the beginning), gas-atomized powders must not be used. On the contrary, powder particles with a more irregular surface can more efficiently be processed to form a mechanically stable layer, as the powder particles grip one another better. Also, the presence of powder particles of different sizes supports the process of mechanical stabilization of the layer by compacting, as smaller powder particles fill the intermediate spaces between the larger powder particles and thus a larger surface is available for producing provisional connections between the individual powder particles.

Some embodiments provide an installation for carrying out a powder-bed-based additive production method, in which a substrate component is provided as dosing device in the processing chamber, on which the layer can be generated and fixed and which can be lowered, with the layer first onto the powder bed. It is particularly advantageous to drive the substrate component together with the powder bed into one and the same processing chamber, as this ensures a reliable closure with respect to the environment. This prevents losses during the handling of the powder and the escape of process gas, with which the processing chamber is filled.

One embodiment of the installation provides that in addition, an auxiliary plate is provided for provisionally generating the layer and subsequently transferring the layer onto the substrate component and/or a compacting plate is provided for compacting the layer. How the substrate component, the compacting plate and the auxiliary plate can be used has already been explained in detail previously in the explanation of the method.

Another embodiment provides that the substrate component and/or the auxiliary plate and/or the compacting plate is coated with a layer reducing the adhesion of the powder (depending on which of these components is used). The advantages of the use of an adhesion-reducing layer are obvious in the case of the auxiliary plate and the compacting plate. The layer should adhere to these components as little as possible, as these components should be removed from the layer again after fulfilling their purpose. The adhesion-reducing layer on the substrate component is advantageous if the retaining forces are already sufficiently generated by a different mechanism (vacuum, electrostatic forces, magnetic forces). In this case, it is interesting if the substrate component can be removed as easily as possible after shutting off these retaining forces. As a result, the surface of the layer is also advantageously damaged as little as possible. If however the retaining forces should be necessary owing to the adhesion of powder particles on the substrate component, so that the layer can be transported reliably, an adhesion-reducing coating of the substrate component must be dispensed with.

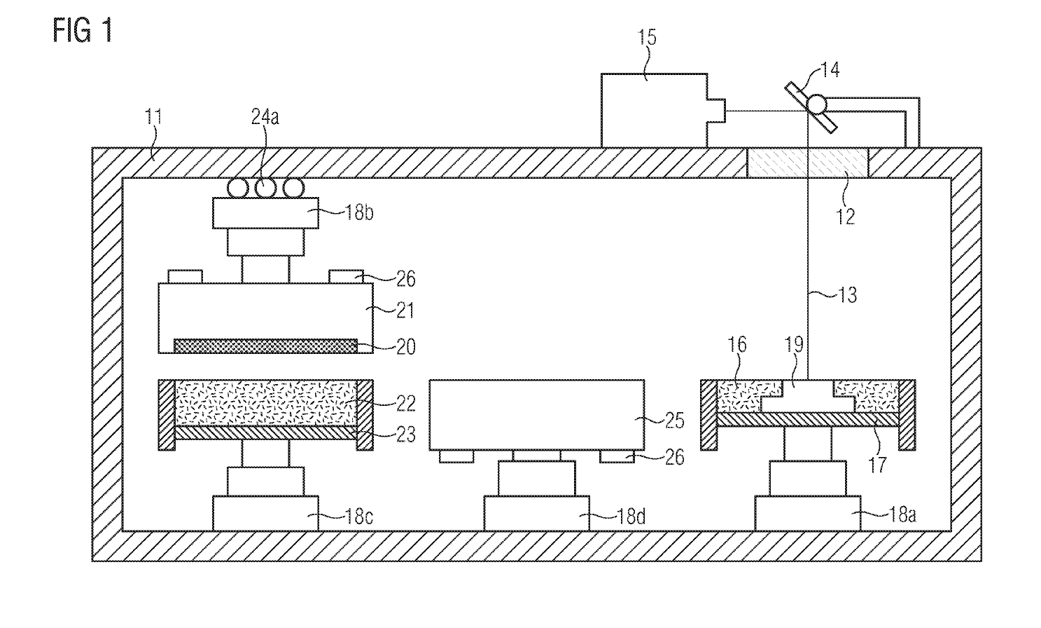

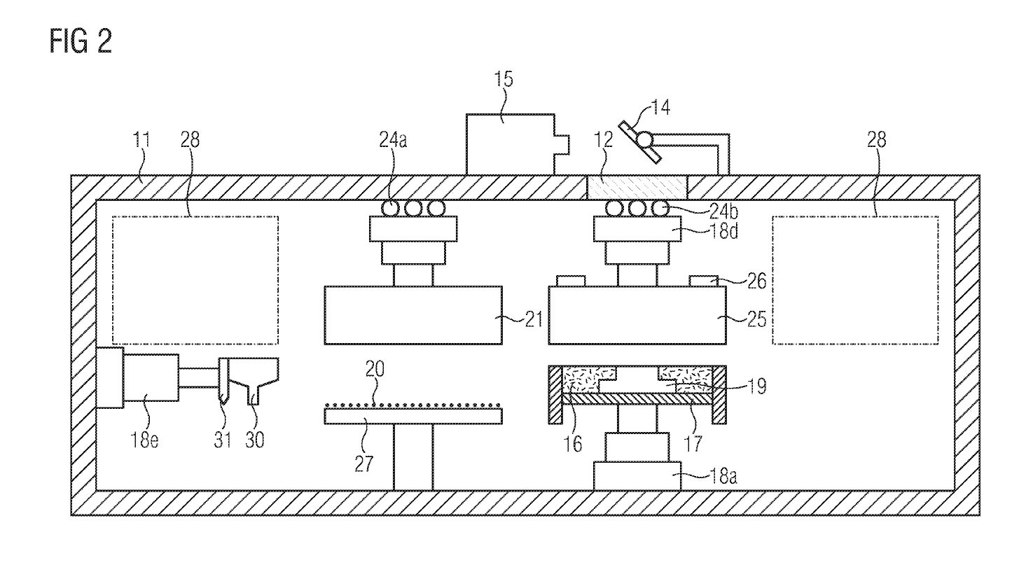

FIGS. 1 and 2 show exemplary embodiments of an installation according for carrying out an additive production method as disclosed herein. An installation for carrying out laser melting as a powder-bed-based additive reduction method has a processing chamber 11, which has a window 12. A laser beam 13 can be introduced into the processing chamber 11 via a deflection mirror 14 through this window, wherein the laser beam 13 is generated by means of a laser source 15. A powder bed 16 is provided in the processing chamber 11, which powder bed is formed on a building platform 17. With the aid of an actuator 18a, the building platform 17 can be lowered in a step-by-step way, so that the powder bed can be formed in layers. A component 19 is generated with the aid of the laser beam 13 in the powder bed by selective fusing of the current layer of the powder bed 16.

A substrate component 21 is provided as a dosing device for new layers 20 of powder for the layer 20 which is currently to be produced. This substrate component can be lowered onto a supply powder bed 22 by means of an actuator 18b, in order to mount a complete layer 20 of the powder from the powder supply present there. During this process, a base plate 23 can be lifted via an actuator 18c, which base plate ensures a contact pressure of the supply powder bed 22 on the substrate component 21. The substrate 21 can subsequently be lifted off from the supply powder bed 22 by means of the actuator 18b and moved horizontally in the processing chamber by means of a linear drive 24a.

By horizontal movement, the substrate component 21 can also be lowered onto a compacting plate 25, which for its part can likewise be lifted by means of an actuator 18d (the actuator 18d is optional, as the relative movement can also be implemented by lowering the substrate component 21). The compacting plate 25 acts like a stamp and can be used for compacting the layer 20.

Furthermore, the substrate component 21 can be brought above the powder bed 16 and lowered there. This allows depositing of the layer 20 on the powder bed 16, which layer can subsequently be selectively fused by means of the laser beam 13 with the formation of a further layer of the component 19. In order to support the compacting process, vibration generators 26, which can generate ultrasound for example, are attached on the compacting plate 25 and on the substrate component 21.

The installation according to FIG. 2 is of similar construction to that in FIG. 1. One difference results from the fact that the compacting plate 25 can be lowered from above similarly to the substrate component 21 using the actuator 18d. A further linear drive 24b is provided for this purpose, so that the compacting plate 25 can be moved over the powder bed 16 or over an auxiliary plate 27. Parking positions 28, which are indicated by means of a dot-dashed line, are provided in the processing chamber for the substrate component 21 and the compacting plate 25 so that the two units do not hinder one another.

The auxiliary plate 27 according to FIG. 2 fulfils the following purpose. The layer 20 can be applied on the auxiliary plate by means of a conventional dosing unit 29 for powder, as if the auxiliary plate were to represent the powder bed of a conventional installation. This has the advantage that the auxiliary plate always provides a completely planar substrate, so that even the conventional dosing method leads to exceptional results when forming the layer 20. The dosing device 29 is moved over the auxiliary plate by means of an actuator 18e, wherein powder is trickled from a storage container 30 onto the auxiliary plate 27, which powder is provided with a planar surface by means of a scraper 31. Any surface faults of the layer 20 are compensated at the latest by placing the substrate component 21 onto the layer 20.

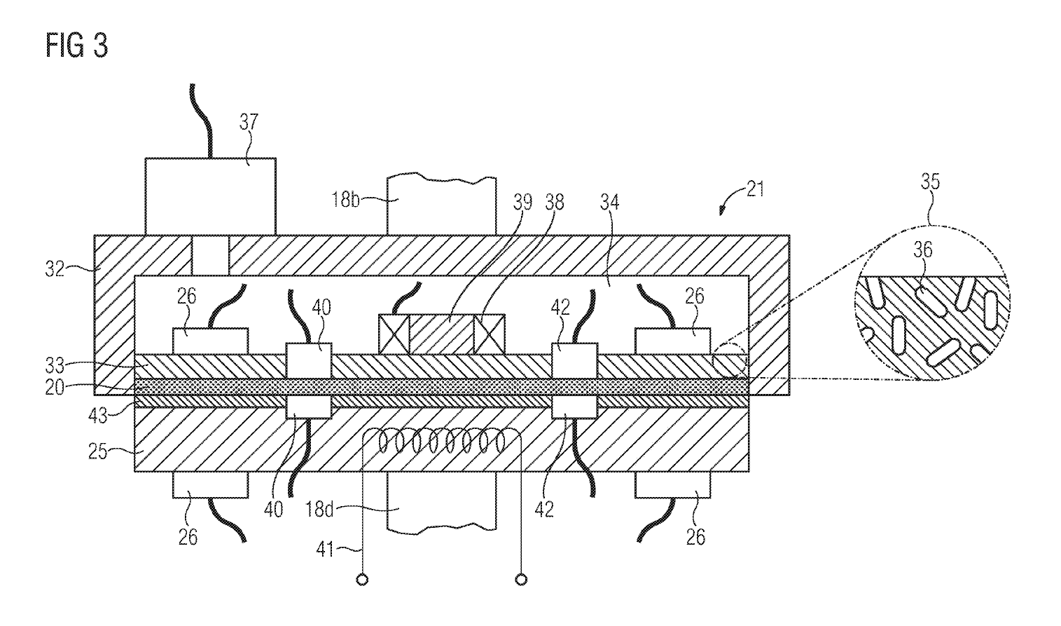

The structure of the substrate component 21 can be drawn from FIG. 3. The substrate component has a housing component 32 which is open at the bottom, into which a plate 33 for mounting the layer 20 is inserted. A cavity 34 is thereby created above the plate 33. The plate 33 is, as the detail 35 shows, penetrated with pores 36, which form a continuous channel system in the plate 36. The cavity 34 can be evacuated by means of a vacuum pump 37, as a result of which a negative pressure can be generated by means of the open channel system of the pores 36, which negative pressure binds the layer 21 to the plate 35.

Alternatively, in the case of a magnetic powder, a magnetic field could be built up by means of a coil 38 and a core 39, which magnetic field generates magnetic retaining forces for the layer 20. Furthermore, not illustrated is the possibility of electrostatically charging the plate 33, so that the layer 20 is bonded to the plate 33 due to electrostatic forces. Not least, a contact pressure, which is exerted by the compacting plate 25, can also lead to an adhesion of the particles of the layer 20 to one another and on the plate 33, as a result of which retaining forces for the layer 20 on the plate 33 are generated. The compacting process can be supported by the vibration generators 26.

Furthermore, it is illustrated that sensors can be integrated into the compacting plate 25 and the substrate component 21. For example, a pressure difference owing to the vacuum in the hollow space 34 compared to the outside world can also be determined by means of pressure sensors 40, in order to assess the retaining force due to the vacuum. If the layer 20 should be heated by means of a heating device 41, a temperature of the layer 20 can be determined by means of temperature sensors 42. In a comparable manner, a heating device can also be provided in the plate 33 (not illustrated). The sensors, heating devices and vibration generators, as illustrated in FIG. 3, can be introduced into the auxiliary plate 27 in a comparable manner.

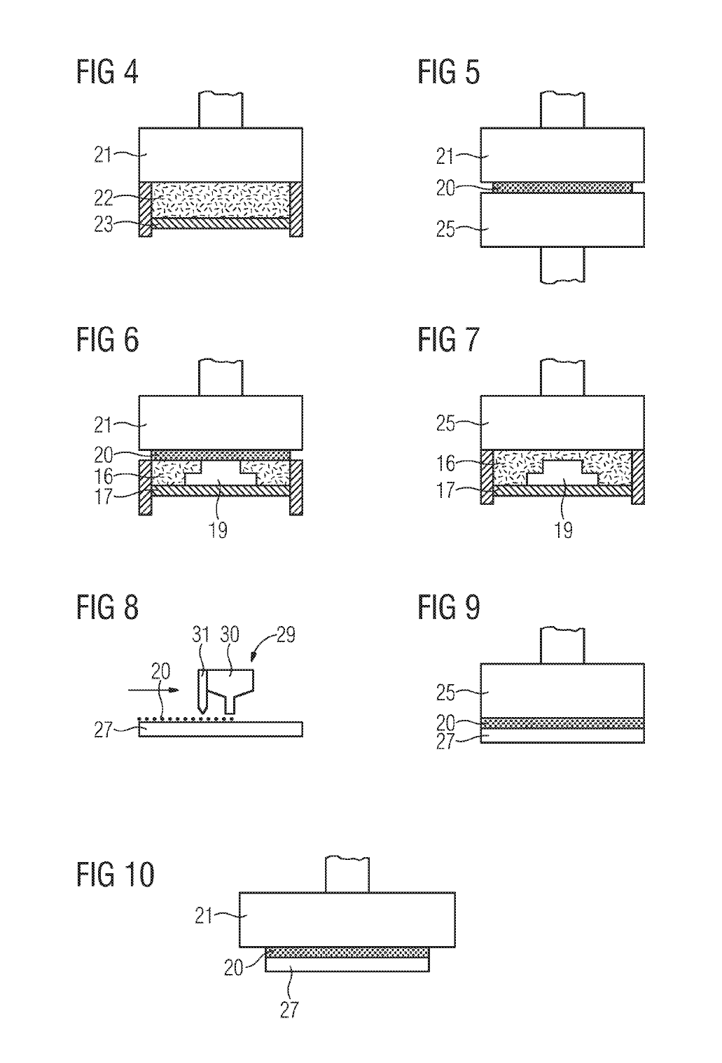

The process sequence for the production of layers 20 on the powder bed 16 can be drawn from FIGS. 4 to 10. According to FIG. 4, a layer can for example be generated by placing the substrate component 21 onto the supply powder bed 22. A layer 20 can be removed from the supply powder bed by means of the substrate component 21, as can be drawn from FIG. 5. This layer can be compacted using the compacting plate 25 according to FIG. 5, wherein the compacting process can be supported using the mechanical devices described for FIG. 3 (for example by generating ultrasound). FIG. 6 illustrates how the layer 20 can be deposited on the powder bed 16, in that the component 19 should be produced generatively. The depositing of the layer 20 can for example be supported by the sound generators 26 described for FIG. 3, which are not illustrated in FIG. 6. Alternatively, a magnetic field can be switched off by switching off the coil 38 according to FIG. 3, so that the fixing of the layer 20 on the substrate component 21 is eliminated.

It can be drawn from FIG. 7 that the layer 20, which according to FIG. 7 has already become part of the powder bed 16 and therefore can no longer be discerned separately, can be compacted from above using the compacting plate 25.

FIG. 8 illustrates how the layer 20 can be produced using the auxiliary plate 27. Powder is deposited on the same on the auxiliary plate 27 using the dosing device 29. According to FIG. 9, this powder is subsequently solidified by means of the compacting plate 25, wherein the auxiliary means described for FIG. 3 can be used here, which auxiliary means are not illustrated in any more detail in FIG. 9. The compacted layer 20 can subsequently be lifted from the auxiliary plate 27 with the aid of the substrate component 21. Here also, the auxiliary means according to FIG. 3, which are not illustrated in anymore detail in FIG. 10, can be used.

What is claimed is:

1. A powder-bed-based additive production method, comprising:
repeatedly performing a powder application including:
applying a layer of a powder onto a powder bed, and
using an energy beam, to selectively fuse the powder to form a layer of a component,
wherein applying the layer of powder onto the powder bed includes:
forming and compacting the layer outside of the powder bed,
temporarily holding the layer on a substrate component via a temporary bond between the layer and the substrate component,
using the substrate component to deposit the layer on the powder bed, and
dissolving the temporary bond between the layer and the substrate component.

2. The production method of claim 1, comprising:
using an auxiliary plate for forming the layer, and
subsequently removing the layer from the auxiliary plate using the substrate component.

3. The production method of claim 1, wherein forming the layer outside the powder bed—includes using the substrate component to pick up powder from a supply powder bed separate from the powder bed.

4. The production method of claim 2, comprising compacting the powder on the auxiliary plate or the substrate component after the formation of the layer using a compacting plate, wherein the compacting plate is pressed onto the layer.

5. The production method of claim 2, wherein the powder is compacted on the auxiliary plate by lowering the substrate component onto the layer.

6. The production method of claim 4, wherein at least one of the substrate component, the auxiliary plate, or the compacting plate is loaded with mechanical vibrations in the ultrasonic range to support the compacting of the powder.

7. The production method of claim 1, wherein the substrate component has a channel system that is open towards a surface thereof, and the layer is held on the substrate component using a vacuum.

8. The production method of claim 1, wherein the layer is held on the substrate component using magnetic or electrostatic forces.

9. The production method of claim 1, comprising heating at least one of the substrate component or the auxiliary plate while the at least one of the substrate component or the auxiliary plate is in contact with the layer.

10. The production method of claim 1, comprising using a sensor to detect at least one of a density of the layer, a temperature of the layer, or pressure differences in the layer, while the layer is located on at least one of the auxiliary plate, the substrate component, or the compacting plate.

11. The production method of claim 1, wherein the layer is compacted after deposition on the powder bed.

12. The production method of claim 4, wherein the compacting of the layer takes place in the powder bed using a compacting plate.

13. The production method of claim 1, wherein the powder used to produce the layer includes particles having particle diameters in the region of two orders of magnitude.

14. A system for performing a powder-bed-based additive production method, the system comprising:
a processing chamber comprising:
a building platform on which a powder bed is generated, and
a dosing device comprising a substrate component configured to form a layer on a powder bed located on the building platform,
wherein the substrate component is configured to be lowered to deposit the layer onto the powder bed.

15. The installation as claimed in claim 14, further comprising at least one of:
an auxiliary plate configured to provisionally generate the layer and subsequently transfer the layer onto the substrate component (or
a compacting plate configured to compact the layer.

16. The installation of claim 14, wherein at least one of the substrate component, the auxiliary plate, or the compacting plate is coated with a layer reducing the adhesion of the powder.
